(19) United States
(12) Patent Application Publication
(10) Pub. No.: US 2023/0145657 A1
(43) Pub. Date: May 11, 2023

(54) IMMERSIVE LEARNING APPLICATION VIRTUAL REALITY FRAMEWORK

(71) Applicant: IntelliMedia Networks, Inc., Leesburg, VA (US)

(72) Inventors: Darshan Sedani, Cerritos, CA (US); Teodros Gessesse, Leesburg, VA (US); Devang Ajmera, Gujaratvv (IN); Joy Shah, Gujarat (IN); Rajkumar Ramakrishnan, Gujarat (IN)

(73) Assignee: IntelliMedia Networks, Inc., Leesburg, VA (US)

(21) Appl. No.: 17/839,219

(22) Filed: Jun. 13, 2022

Related U.S. Application Data
(63) Continuation of application No. 17/839,129, filed on Jun. 13, 2022.
Application No. 17/839,129 is a continuation of application No. 17/839,025, filed on Jun. 13, 2022.
Application No. 17/839,025 is a continuation of application No. 17/838,924, filed on Jun. 13, 2022.
Application No. 17/838,924 is a continuation of application No. 17/592,371, filed on Feb. 3, 2022.
Application No. 17/592,371 is a continuation of application No. 17/592,296, filed on Feb. 3, 2022.
Application No. 17/592,296 is a continuation of application No. 17/523,504, filed on Nov. 10, 2021.

(51) Int. Cl. G09B 5/06

(52) U.S. Cl. CPC G09B 5/065

(57) ABSTRACT

Immersive Learning Application Virtual Reality Framework (ILAVRF) is an artificial environment for unity and android devices for creating an enhanced interactive and immersive audio-visual environment that is created with software and presented to the user in such a way that the user suspends belief and accepts it as a real environment.

### CROSS-REFERENCE TO RELATED APPLICATIONS

This application is a continuation application of 17/839,129, filed, Jun. 13, 2022, which is a Continuation of U.S. Pat. Application Serial No. 17/839,025, filed Jun. 13, 2022, which is a Continuation of U.S. Pat. Application Serial No. 17/838,924, filed Jun. 13, 2022, which is a Continuation of U.S. Pat. Application Serial No. 17/592,371, filed Feb. 3, 2022, which is a Continuation of U.S. Pat. Application Serial No. 17/592,296, Feb. 3, 2022, which is a Continuation of U.S. Pat. Application Serial No. 17/523,504, filed Nov. 10, 2021, the entire disclosures of which are herein incorporated by reference as a part of this application.

### FIELD

This invention is in the field of the interaction among and between educational software systems, learning systems, courseware management, informational communications and visualization systems, and virtual reality presentation system software, students, teachers, and learning system administrators.

### DESCRIPTION OF RELATED ART

As the Internet has grown in speed and computing power, and with the rise of cloud-based data storage and software as a service, online education has become increasingly enabled. Many efforts at standardizing online education and providing tools to enable multiple kinds of course materials to be mixed together have arisen. A critical threshold has also been reached where networking bandwidth and data transfer speeds of massive amounts of data are now sufficient to allow blending of live data streams. These factors have served to open a wide range of opportunities for designing and serving so-called massive open online courses to students worldwide.

Another convergence of technology is also maturing: the widespread availability of multiple kinds of user devices such as laptop computers, mobile phones, mobile tablets of various kinds, next-generation television program management services (so-called over-the-top (“OTT”) services), and virtual reality devices and related services. These devices are becoming sufficiently commonplace that widespread familiarity with their use is an enabler for convergent inter-operation of such device to enhance information delivery and interactivity. Users of such devices now often possess sufficient skills to be able to operate multiple devices and coordinate information between them with ease.

Taken together, these factors provide opportunities for development of inter-operating education systems which take advantage of multiple information delivery modalities including plain text, interactive text, audio, video, collaborative workspaces, and various combinations of live interactions between students and teachers while sharing and even contributing to information flows displayed on multiple devices simultaneous.

Such new systems serve to enhance learning rates of student, collaboration rates among professionals, and may even serve to enhance the rate of new discoveries in science by scientific research communities.

The Immersive Learning Application Virtual Reality Framework disclosed hereunder is a component of one such integrative software system in this new genre.

### SUMMARY

Immersive Learning Application Virtual Reality Framework (ILAVRF) is a component system of Immersive Learning Application (ILA), which in turn is a cloud-based integrated software system providing a rich context for education of trainees, employees in enterprise organizations, students in institutional settings, as well as individual students, through the operation of courseware, testing, skills validation and certification, courseware management, and inter-personal interactions of students and teachers in various ways. The core concept is providing a learning environment which is immersive in the sense that the student can utilize every available communications and display technology to be fully immersed in a simulated or artificial environment. The student is able to tune this environment to his/her own optimum style of information absorption.

The benefits and applications of virtual reality (VR) in different scenarios of immersive learning is widely explored. VR possesses much potential and its application in education has seen much research interest lately. However, little systematic work currently exists on how researchers have applied immersive VR for higher education purposes that considers the usage of both high-end and budget head-mounted displays (HMDs). The evaluation of educational VR applications has primarily focused on usability of the VR apps instead of learning outcomes and immersive VR has mostly been a part of experimental and development work rather than being applied regularly in actual teaching. Nevertheless, VR seems to be a promising sphere as it indicates a better reception of this technology in many disciplines.

ILAVRF is an artificial environment for Unity and Android devices for creating an enhanced interactive and immersive audio-visual environment that is created with software and presented to the user in such a way that the user suspends belief and accepts it as a real environment. The simplest form of virtual reality is a 3-D view that can be explored interactively at a personal device, usually by touch screen mobiles so that the content of the image moves in some direction or zooms in or out.

### BRIEF DESCRIPTION OF THE DRAWINGS

FIG. 1 is a diagram illustrating the major system components and their data flows in relationship to each other.

FIG. 2 is a diagram illustrating system components and data flows in relation to software infrastructure elements within which the system runs, and supporting software services.

### DETAILED DESCRIPTION

ILAVRF is a software module of ILA providing the method comprising receiving an interactive content file overlaid with a video to be played by the user device, the interactive content file comprising: one or more interactive documents arranged to be overlaid on the video when the video is played by the user device, wherein the one or more interactive content file have associated information which is accessible by a user when a respective content file is selected via a user interface of the user device, and information defining as reference material to be overlaid on the video.

ILAVFR supports both 3-degree-of-freedom systems (“3 DoF”) and six-degree-of-freedom (“6 DoF”) systems. 3 DoF headsets allow tracking of rotational motion but not translational. With a user wearing a VR headset, the system is tracking whether a user: 1) Looks left or right; or 2) Rotates their head up or down; or 3) Pivots left or right.

ILAVFR supports 3 DoF headsets comprising the list:

Google Cardboard, Oculus Go, Merge VR, Samsung Gear VR, and Google Daydream.

6 DoF headsets allow tracking of translational motion as well as rotational motion. The system can determine whether a user has rotated their head and moved: 1) Forward or backward; or 2) Laterally or vertically; or 3) Up or down.

ILAVFR supports 6DoF headsets comprising the list: Oculus Rift, Oculus Quest, HTC Vive, and Windows Mixed Reality.

ILAVFR also supports cross-wearable compatibility, comprising the list of devices: HTC Vive, HTC Vive Pro, Oculus Rift, Oculus Quest, PlayStation VR.O, Oculus Go, Lenovo Mirage Solo, Samsung Gear VR, Google Daydream View, Valve Index, Homido V2 Virtual Reality Headset, Zeiss VR and One Plus Virtual Reality Headset.

ILAVFR can provide an augmented reality layer in the context of a 6 DoF application.

ILAVFR can also provide a second screen experience within the virtual reality display, projecting a second screen into the visual field of the headset.

In greater detail: The immersive audio-visual environment enables participants to enjoy true interactive, immersive audio-visual reality experience in a variety of applications. The immersive audio-visual system comprises an immersive video system, an immersive audio system, and an immersive audio-visual production system. The video system creates immersive stereoscopic videos that mix live videos, computer-generated graphic images, and human interactions with the system. The immersive audio system creates immersive sounds with each sound resource positioned correctly with respect to the position of an associated participant in a video scene. The immersive audio-video production system produces enhanced immersive audio and videos based on the generated immersive stereoscopic videos and immersive sounds. A variety of applications are enabled by the immersive audio-visual production including casino-type interactive gaming system and training system.

ILAVRF includes a computer method for producing an interactive immersive simulation program, the method comprising recording one or more immersive video scenes, an immersive video scene comprising one or more participants and immersion tools. calibrating motion tracking of the immersive video scenes; analyzing the performance of the participants. editing the recorded immersive video scenes and creating the interactive immersive simulation program based on the edited immersive video scenes.

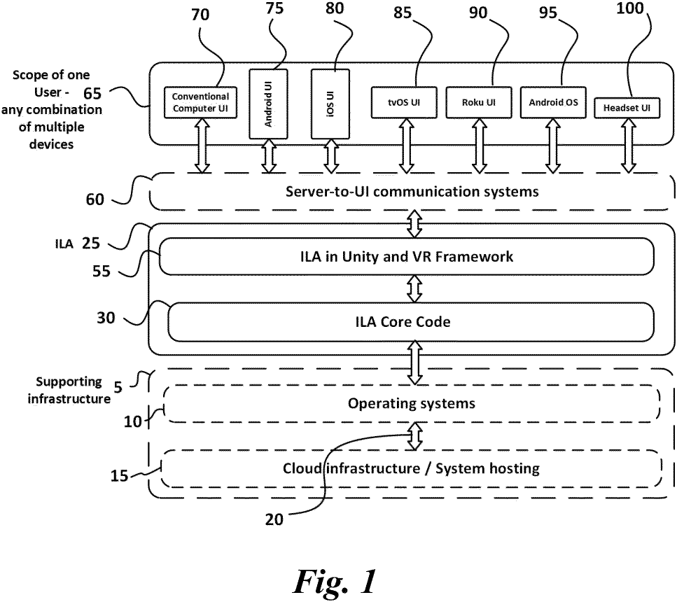

Referring to FIG. 1, ILA is supported in a context of other software which are not parts of which ILA is comprised but are necessary for ILA operating correctly. These components are illustrated in dashed outlines. A Supporting infrastructure 5 is comprised of a so-called cloud hosting environment of servers 15, operating systems 10, and Internet components in communication with each other by means of data flows 20, indicated generically by double arrows throughout FIG. 1. Communications between said servers and remote user devices is through generic Internet server-to-user-interface communication systems 60.

The software architecture of ILA 25 is comprising a body of core code 30, together with distinct modules providing specific services. The core code 30 in turn operates a framework supporting displays in virtual reality and so-called mixed reality user device contexts 55.

The module ILAVRF 55 is communicating through said server-to-user-interface communication systems 60, to one or any combination of an array of user devices within the scope 65, the array of devices and displays comprising a conventional computer display 70, an Android user interface display 75, an iOS user interface display 80, a tvOS user interface display 85, a Roku user interface display 90, an Android OS user interface display 95, and a virtual reality headset user interface display 100.

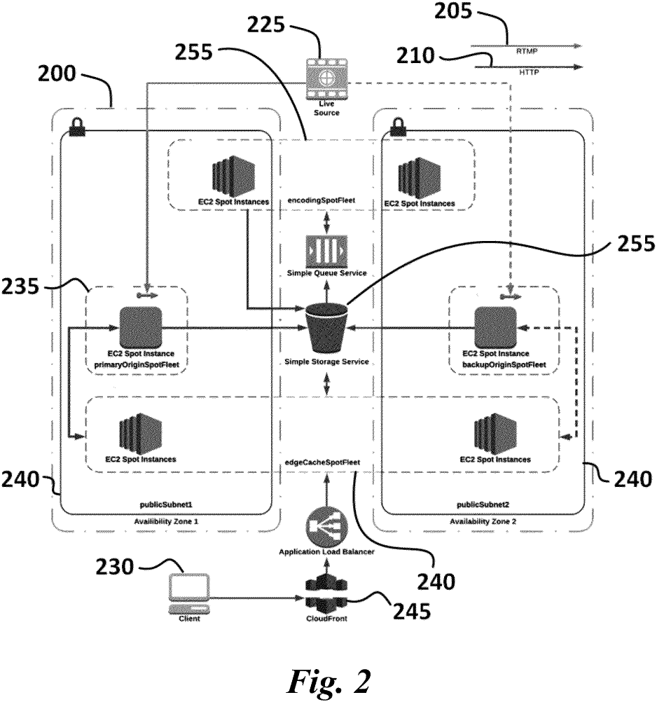

FIG. 2 is a diagram illustrating the system architecture of Immersive Learning Application Virtual Reality Framework (ILAVRF) according to an embodiment, together an example process sequence. Background software infrastructure is provided by Amazon Web Services, collectively 200, together with all unidentified drawing elements in the Figure. Data flowing through the Real Time Messaging Protocol (RTMP) protocol 205 is illustrated with gray arrows. Data flowing through the HTTP protocol is illustrated with black arrows 210.

An example process sequence occurs as follow.

The event encoder 225 publishes the RTMP source to multiple origin 235 elastic IP addresses for packaging into the HTTP Live Stream (HLS) adaptive bitrate. The client 230 requests the live stream through the CloudFront Content Delivery Network (CDN) 245. The origin 235 responds with the appropriate HLS stream. The edge fleet 240 caches media requests from clients and elastically scales across both Availability Zones 250 to meet peak demand. CloudFront 245 caches media at local edge Points of Presence (PoPs) to improve performance for users and reduce the origin load. When the live event is finished, the Video on Demand (VOD) asset is published to Simple Storage Service (S3) 255. An S3 event is then published to Simple Queue Service (SQS) 255. The encoding fleet processes the read messages from the SQS queue, processes the VOD clips, and stores them in the S3 bucket 255.

We claim:

1. A software structure and operating means comprising
a) A centralized software structure serving as a framework for displaying and operating content on virtual reality devices; and
b) Operating on virtual reality and mixed reality operating systems comprising Unity and Android; and
c) Enabling user control of elements of virtual reality and mixed reality displaying on wearable virtual reality display devices; and
d) Integrating user controllable devices through which elements of the virtual and mixed reality environments are changing, said controllable devices comprising pointers, gesturing devices, gloves, eye-tracking, head tracking, and user motion tracking; and
e) Displaying content from one or a plurality of sources, said sources comprising
i) a virtual environment, and
ii) a document of any computer file format; and
ii) Internet Web content; and
iv) interactive fictional characters moving through a virtual environment
f) Enabling user interaction with any element displayed in the virtual or mixed reality displaying on user’s wearable device(s).

2. A software structure and operating means of claim 1, with a realtime image recognition framework integrated within the operation of a 6 degree-of-freedom virtual reality implementation of the system.
